(19) United States
(12) Patent Application Publication
(10) Pub. No.: US 2020/0305489 A1
(43) Pub. Date: Oct. 1, 2020

(54) METHOD FOR PRODUCING CELLULOSE NANOFIBER USING ALMOND SEED COAT

(71) Applicants: TSUKUBA DAIRY PRODUCTS CO., INC., Ibaraki (JP); FORESTRY AND FOREST PRODUCTS RESEARCH INSTITUTE, Ibaraki (JP)

(72) Inventors: HIROSHI EBITSUBO, IBARAKI (JP); YOSHINAO HORIE, IBARAKI (JP); TSUTOMU IKEDA, IBARAKI (JP); NORIKO HAYASHI, IBARAKI (JP)

(21) Appl. No.: 16/506,185

(22) Filed: Jul. 9, 2019

(30) Foreign Application Priority Data
Mar. 29, 2019 (JP) 2019-067088

(51) Int. Cl. A23L 33/24; A23L 5/49; A23L 5/10

(52) U.S. Cl. CPC A23L 33/24; A23V 2002/00; A23L 5/19; A23L 5/49

(57) ABSTRACT

The method of the present invention for producing cellulose nanofiber from almond seed coat includes alkali cooking a food manufacturing by-product containing plant fiber with an alkali acceptable for food use, washing the object, bleaching the pulp component containing cellulose and hemicellulose thus obtained using a chemical acceptable for food use, washing the object with water, and mechanically fibrillating and grinding the pulp component obtained above, thereby obtaining cellulose nanofiber. The present invention allows efficient production of highly safe cellulose nanofiber from a food manufacturing by-product as a raw material, or almond seed coat acceptable for food use.

### CROSS-REFERENCE TO RELATED APPLICATIONS

The present application claims priority of Japanese Patent Application No. 2019-067088, filed on Mar. 29, 2019, the disclosure of which is incorporated by reference herein in its entirety for all purposes.

### BACKGROUND OF THE INVENTION

### Technical Field

The present invention relates to a method for producing cellulose nanofiber using almond seed coat (or almond skin) acceptable for food use. More specifically, the present invention relates to a method for producing cellulose nanofiber from a food manufacturing by-product containing plant fiber.

### Related Art

Cellulose nanofiber (hereinafter may be referred to as “CNF”) is known as a functional biomass material made by high level of processing to a nano size (refining) of lumber fiber (pulp) obtained mainly from lumber to nano-order of one several hundredth, and the cellulose produced by plant has the form of fine fiber referred to as microfibril. CNF is produced by fibrillating a piece of microfibril to several tens to several hundreds of pieces, and has a nano-size width. Additionally, CNF is derived from plant fiber, and thus its production and disposal impose a small burden on environment, and has a light weight. Furthermore, CNF is known to have marked characteristics such as a high strength and a high modulus of elasticity, good elasticity comparable to that of glass, high barrier property to oxygen and other gases, and addition of thixotropic properties.

Regarding the method for producing CNF, various production methods and improved methods are reported, these methods including simplification of the production process and reduction of the energy cost.

In prior art production methods, raw materials are generally woody biomass materials derived from wood, for example, lumber such as conifers, hardwood, lumber for building, sawdust, lumber chips, pulp, and recycled paper. Plant fibers are contained in various non-wood materials other than lumber, such as straws, bagasse, and agricultural waste, and they also can be used as a raw material of CNF.

Biomass raw materials are the most abundant resource on the earth. However, woody biomass materials with the highest accumulated amount are usually used as the materials for producing CNF, so that CNF cannot be immediately accepted for food use.

Therefore, the use of an object which is intrinsically food as a raw material is suggested, but there are not so many report about the technique producing CNF from such raw material as long as the inventors researched.

Thin seed coat of almonds is composed mainly of cellulose, hemicellulose, and lignin.

In general, almond products are broadly divided into almonds with seed coat and naked (peeled) almonds. In the production process of these almond products, when the end product is produced, almonds are usually acquired as a raw material after the outer hard shell is removed, or with seed coat, and used for production.

Almonds are generally eaten with seed coat (thin skin) or peeled. It is said that many of the almonds (with seed coat) processed in production plants are subjected to seed coat peeling treatment in the producing process of the product. The amount of seed coat generated by seed coat peeling treatment may exceed several hundreds of tons a year. Therefore, effective utilization of the seed coat generated by peeling and addition of value to them are desired because they will contribute to the reduction of environment load.

In addition to almond seed coat, effective utilization is also desired for by-products containing many plant fibers such as bean curd refuse, rice bran, and wheat bran generated in food producing processes.

### PRIOR ART LIST

### Patent Document

Patent Document 1: Japanese Patent Application Laid-Open Publication No. 2008-150719

### SUMMARY OF THE INVENTION

The present invention is intended to provide a method for efficiently producing highly safe CNF from a food manufacturing by-product as a raw material, or almond seed coat acceptable for food use.

The inventors have succeeded in producing CNF from almond seed coat by the procedure including subjecting almond seed coat to alkali cooking using an alkali acceptable for food use for delignification, bleaching the seed coat as additional delignification using a chemical acceptable for food use, and subjecting the cellulose and hemicellulose thus obtained to mechanical cracking for processing to a nano size, wherein the chemicals used in this procedure are acceptable for food use. The chemicals used herein are highly safe as food, and the conditions and process of alkali treatment are milder and simpler than the case of producing CNF from a woody material, and processing to a nano size can be achieved with relatively simple mechanical processing. This has allowed simple and efficient production of CNF which is usable and highly safe for food use.

Furthermore, they also succeeded in the application of the production method to the production of CNF from bean curd refuse, rice bran, and wheat bran as raw materials.

The present invention is based on these findings.

More specifically, the present invention provides the following invention.

<1> A method for producing cellulose nanofiber including

alkali cooking a food manufacturing by-product containing plant fiber using an alkali acceptable for food use, followed by washing with water,

bleaching the pulp component containing cellulose and hemicellulose thus obtained using a chemical acceptable for food use, followed by washing with water, and then

mechanically fibrillating and grinding the pulp component obtained above, thereby obtaining cellulose nanofiber.

<2> The method of <1>, wherein the food manufacturing by-product containing plant fiber is selected from the group consisting of almond seed coat, bean curd refuse, rice bran, and wheat bran.

<3> The method of <1>, wherein the food manufacturing by-product containing plant fiber is almond seed coat.

<4> The methods of <1> to <3>, wherein sodium hydroxide is used as an alkali acceptable for food use.

<5> The methods of <1> to <4>, wherein any one of sodium hydroxide, sodium hypochlorite, ozone, oxygen, hydrogen peroxide, or a mixture of them is used as a chemical acceptable for food use.

<6> The methods of <1> to <5>, wherein processing to a nano size by mechanical grinding is carried out using a wet mill, a grinder, a high pressure collision grinding apparatus, an ultrasonic homogenizer, or a high pressure homogenizer.

<7> Cellulose nanofiber which is accepted for food use obtained by the methods of <1> to <6>.

According to the present invention, highly safe CNF which may be used for food use can be simply and efficiently produced from a food manufacturing by-product raw material such as almond seed coat as a raw material.

In prior art, CNF is often produced from a woody biomass material, but the application of CNF produced from a woody biomass material is mostly other than food use such as industrial use. The reason for this is likely that the origin of raw materials (for example, lumber) and chemicals used for the raw materials are not intended to be used for food, so that they do not adhere to food grade, and cannot be immediately used for food use.

On the other hand, as in the present invention, CNF produced from a food manufacturing by-product such as almond seed coat using a production process in consideration of food use is highly safe for food use, and can be used without worry. Additionally, CNF production through mechanical processing allows size adjustment. CNF produced by the present invention allows, for example, function addition to food using the function of CNF, such as a food thickening agent.

Additionally, the method of the present invention for producing CNF acceptable for food use can use food manufacturing by-products which are generally discarded. Therefore, the method contributes to recycling of waste, and is expected to reduce environment load through effective utilization of waste.

CNF produced by the present invention is for food use and highly safe, and thus may be used as a food and beverage material and a food additive (for example, a thickening agent), and is also suitable for industrial use.

### BRIEF DESCRIPTION OF THE DRAWINGS

FIG. 1 depicts photographs of almonds with seed coat and naked almonds, in which left photograph depicts almonds with seed coat and the right photograph depicts almonds from which seed coat has been peeled;

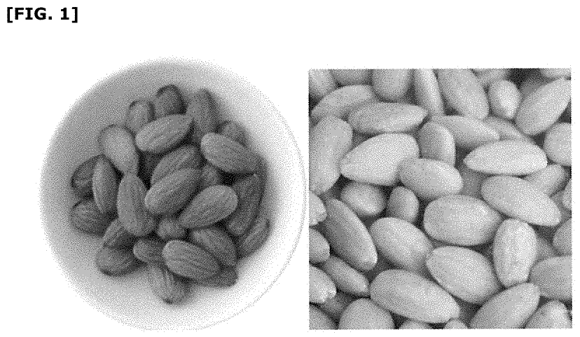

FIG. 2 is a photograph of seed coat obtained by peeling almonds; and

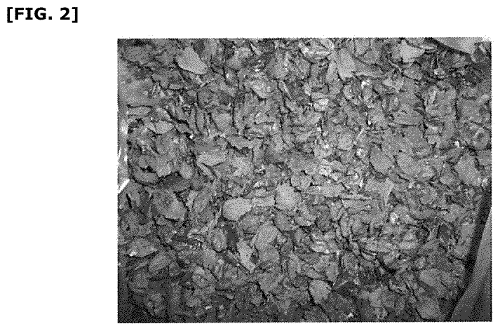

FIG. 3 is an electron micrograph of CNF derived from almond seed coat produced according to the present invention.

### MODE FOR CARRYING OUT THE INVENTION

An embodiment of the present invention is described below.

Method for Producing Cellulose Nanofiber (CNF)

The method for producing CNF by the present invention includes, as described above, alkali cooking a food manufacturing by-product containing plant fiber using an alkali acceptable for food use, followed by washing with water,

bleaching the pulp component containing cellulose and hemicellulose thus obtained using a chemical acceptable for food use, followed by washing with water, and then

mechanically fibrillating and grinding the pulp component obtained above, thereby obtaining CNF. The CNF thus obtained may be used food use.

As described above, in the present invention, food manufacturing by-products containing plant fiber such as almond seed coat are so soft and can be eaten in the form of almonds with seed coat, so that require a far lower energy cost for producing CNF in comparison with that for woody biomass, and are easily processed into CNF through alkali cooking and bleaching using chemicals all of which are certified as food additives. Additionally, bean curd refuse, rice bran, and wheat bran, which are treated as food manufacturing by-products even they are edible parts, contain dietary fiber, and can be processed into CNF according to the method of the present invention.

(1) Raw Materials

In the production method of the present invention, as a raw material, a food manufacturing by-product containing plant fiber is used. The plant fibers are those containing at least cellulose, and usually contain cellulose, hemicellulose, lignin, protein, and lipid, though the components somewhat depend on the raw material. The components necessary for producing CNF are cellulose and hemicellulose (pulp component).

The food manufacturing by-product containing plant fiber is those containing plant fiber, and refers to a by-product generated during selection of the edible portion in the food producing process. For example, for food using fruits and seeds, examples of the by-product include residues excluding the portion used for food use such as fruit pieces, fruit skins, and seeds, and husks, skins, and fragments of seeds.

Specific examples of food manufacturing by-product containing plant fiber include almond seed coat, bean curd refuse, rice bran, and wheat bran. Preferred examples of the food manufacturing by-product include almond seed coat, bean curd refuse, rice bran, and wheat bran, and more preferred example is almond seed coat.

The case wherein the raw material is almond seed coat is further described. An almond fruit is consisted of pulp and seed, and the seed is broken to take out an embryo from inside. Generally, it is called almond with seed coat, and the brown seed coat is mechanically peeled and used as a raw material.

Almond is eaten with seed coat or naked. In general, consumers will not take the trouble of peeling the seed coat for eating almonds (the way of eating is different from that for peanut), so that almond seed coat will not be distributed in a large amount other than processing companies. Therefore, different from woody raw materials derived from trees, usually, almond seed coat is a single raw material without contamination, and thus is regarded as a desirable raw material.

The same thing applies to other raw materials such as bean curd refuse, rice bran, and wheat bran.

(2) Alkali Cooking Treatment

According to the method of the present invention, a food manufacturing by-product containing plant fiber is subjected to alkali cooking treatment using an alkali acceptable for food use, and then washed with water. As a result of this, a pulp component (first pulp component) containing cellulose and hemicellulose is obtained.

Preferably, the pulp component thus obtained includes cellulose and hemicellulose as main ingredients, and the term “main ingredients” herein means that the total content of cellulose and hemicellulose is 50% or more, and more preferably 80% or more with reference to the whole pulp component (based on weight). This alkali cooking treatment removes lignin contained in the food manufacturing by-product as much as possible. Accordingly, the alkali cooking treatment is also referred to as delignification treatment.

In prior art method for producing CNF, a woody biomass material is often used because its accumulation amount is abundant. When a woody biomass material is used, usually, in the production process, in advance of the alkali cooking process, the material must be finely ground into chips. Thereafter, alkali cooking treatment is carried out using an alkali, thereby removing a great extent of lignin. KP process (kraft pulp process) using a mixed solution of sodium hydroxide and sodium sulfide is generally used for woody biomass materials. For example, wood chips are cooked at 150 to 170° C. for several hours and the pulp component is taken out from them. However, of the chemicals used herein, sodium sulfide is a chemical which is not certified as a food additive, and the installment and operation of the desulfurization apparatus for removing the sulfur content require much cost.

Mechanical pulping (MP) process uses no chemical, but the process only mechanically fibrillates wood into woody fiber, and removes little lignin. Therefore, it is difficult to directly obtain cellulose nanofiber from mechanical pulp.

In comparison with such woody biomass materials, food manufacturing by-products such as almond seed coat have been already processed, so that can be directly cooked without requiring pretreatment such as grinding.

In the present invention, an alkali acceptable for food use is used in the alkali cooking treatment. The “alkalis acceptable for food use” are usually those accepted as food additives, and typical examples include sodium hydroxide. Sodium hydroxide is used in the form of an aqueous solution.

The usage of the alkali (for example, sodium hydroxide) may be appropriately changed according to the amount of the food manufacturing by-product to be used.

When the alkali is sodium hydroxide, for example, 10 to 50% (preferably 15 to 30%) of sodium hydroxide with reference to the solid content of the food manufacturing by-product (for example, solid content of almond seed coat) may be added, and the liquid ratio is adjusted to 1:3 to 1:50 with reference to the solid content of the food manufacturing by-product (for example, solid content of almond seed coat). At this time, the liquid ratio is adjusted so as to immerse the whole of the food manufacturing by-product into the liquid containing sodium hydroxide.

The temperature of alkali cooking treatment (alkali cooking temperature) is, for example, from 150 to 180° C. (preferably from 160° C. to 170° C.), and the processing is continued for 30 minutes to two hours after the target temperature is attained.

The alkali cooking treatment usually uses a pressure vessel (class-1 pressure vessel if it is large).

After completion of alkali cooking, the pressure is relieved, and the vessel is cooled to a temperature at which the vessel can be taken out.

Typical uses of the chemicals which may be used in the production of CNF according to the present invention are as follows. Sodium hydroxide (hereinafter referred to as NaOH) is used for peeling of peach and glossing of the surface of pretzel. Sodium hypochlorite (hereinafter referred to as NaClO) is used for sterilization of water supplies and disinfection of plants and fruits, hydrogen peroxide (H₂O₂) is used for bleaching of Udon noodles and Kamaboko (boiled fish paste), ozone (O₃) is used for sterilization of water supplies, and O₂ is oxygen. All of them are accepted for food use.

After alkali cooking treatment, usually, the pulp component thus obtained is washed and rinsed.

More specifically, the pulp component and the cook liquid obtained after alkali cooking are separated, and the pulp component is washed with water. The water used herein is distilled water, purified water, or an equivalent. The pulp component usually has a high moisture content, so that the pulp is rinsed while forcibly removing its moisture with suction filtration, a centrifugation dehydrator, or compressor.

Completion of washing and rinse can be decided by confirming the pH.

(3) Bleaching Treatment

According to the method of the present invention, the pulp component obtained by alkali cooking treatment (more specifically, the first pulp component) is bleached using a chemical acceptable for food use, and washed with water. As a result of this, a bleached pulp component (second pulp component) is obtained. The bleaching treatment process may be carried out according to the desired degree of bleaching. Lignin may not be perfectly removed even by the above-described alkali cooking treatment, and in this case, the remaining lignin may be further removed by bleaching treatment.

In the present invention, in the bleaching treatment, a chemical acceptable for food use (more specifically, a bleaching agent) is used. Examples of the chemical include any one of sodium hypochlorite (NaClO), hydrogen peroxide (H₂O₂), ozone (O₃), oxygen (O₂), sodium hydroxide (NaOH), and mixtures of them. Preferably, sodium hydroxide, sodium hypochlorite, or a mixture of them is used (or combined), and even more preferably, a mixture of sodium hydroxide and sodium hypochlorite is used.

The bleaching process is described below, using oxygen, sodium hydroxide, and sodium hypochlorite as the chemicals.

The pulp obtained by alkali cooking is charged into a pressure vessel, and may be treated with a sodium hydroxide liquid so as to adjust the pH to 11 to 14. Thereafter, the vessel is capped, oxygen (O₂) is blown into the pressure vessel several times at a pressure of 2 to 7 kg/cm², thereby replacing nitrogen in the pressure vessel with oxygen.

After completion of substitution with oxygen, the vessel is sealed with the oxygen pressure in the vessel kept at 1 to 15 kg/cm², and the vessel is allowed to stand at 90 to 170° C. for 0.5 to 2 hours. When the pulp amount in the pressure vessel is large, much oxygen is consumed, so that the sealing pressure must be high. If the pulp amount is not so large, the sealing pressure may be not so increased.

Oxygen bleaching may be omitted because it is supplementary to NaClO bleaching carried out after this operation.

After completion of standing, 0.5 to 10% of a NaClO solution is added with reference to 1 of the solid content of the pulp. The liquid ratio is adjusted to 1:3 to 1:20 with reference to the solid content amount of the pulp.

During bleaching, a NaOH solution is added as appropriate so as to adjust the pH to 10 to 13.

During bleaching, the pulp liquid is stirred with the temperature kept at 10 to 75° C., and bleaching is finished in 0.5 hours to five hours. If the progress of bleaching stops, NaClO is added as needed and the pH is adjusted.

The end point of bleaching may be, as a guideline, when L* on the L*a*b* colorimetric system becomes about 60 to 70.

After the bleaching treatment, usually, the pulp component thus obtained is washed and rinsed.

More specifically, the pulp after completion of bleaching is rinsed with, for example, suction filtration, a centrifugation dehydrator, or a compressor, until filtered water of the pulp becomes about pH 7.

In the process of the method of the present invention, the last washing and rinsing are carried out at this point, so that the pulp may be boiled at the end of rinsing so as to remove residual chlorine.

In prior art production method of CNF, a woody biomass material is used, but a woody biomass material may further require another process of “delignification” in advance of bleaching. There are strong demands for achieving high whiteness by bleaching treatment, so that stronger bleaching treatment is required, and stronger bleaching agents tend to be usually used than for food use. For example, multistage bleaching is generally used in papermaking companies. The multistage bleaching uses chlorine, alkali extraction, hypochlorous acid or chlorine dioxide, alkali, and chlorine dioxide in this order, and referred to as five-stage bleaching.

When food use is considered as in the present invention, the chemicals to be used must be acceptable for food use, and rather mild conditions and chemicals are usually used.

(4) Processing to a Nano Size

According to the method of the present invention, the pulp component obtained above is mechanically fibrillated and crushed, thereby obtaining CNF. Mechanical fibrillating can be stopped when CNF has a relatively large size, and this solves safety problems with food which may be caused by nano-size CNF.

Commonly, processing to a nano size is said to have difficult aspects. The reason for difficulty in processing to a nano size is that, when pulp derived from woody biomass is used, cellulose microfibril (CMF) tends to be immediately and densely agglutinated by refinement and drying, and once agglutinated, high energy such as a high pressure homogenizer is required to loosen the lumps.

Examples of the method for processing of the pulp component thus obtained to a nano size include mechanical fibrillating, acid hydrolysis, chemical treatment, and enzymatic hydrolysis. In prior art, CNF processing from a woody biomass material usually use mechanical fibrillating (for example, a grinder method or fibrillating using a high pressure homogenizer such as a water jet machine), acid hydrolysis (for example, sulfuric acid hydrolysis), chemical treatment (for example, TEMPO oxidation using a chemical), or enzymatic hydrolysis (for example, a method using cellulase). CNF obtained by mechanical fibrillating has a width ranging from several to several hundred nm, but the width often converges on 20 nm, and the length may reach several of μm.

In the present invention, as described above, mechanical grinding (mechanical fibrillating) is used. In the present invention, a food manufacturing by-product containing plant fiber is used as a raw material, and it was found that a material which is not subjected to drying process after pulping can be sufficiently processed to a nano size by mechanical grinding. The width of CNF to be obtained varies from the unit of a piece of microfibril (2 to 3 nm) produced by plants to 100 nm, which tends to be thinner than that derived from a woody biomass, and the length may reach several μm. Accordingly, the aspect ratio, which is the ratio between the diameter and length, tends to be higher than that from a lumber biomass. When a woody biomass material is used, TEMPO oxidation is used to produce CNF by fibrillating the material to a single unit of cellulose microfibril, but TEMPO((2,2,6,6-tetramethylpiperidine 1-oxyl), which is an oxidant used for selective oxidation, is a chemical which has not been accepted for food use. Furthermore, in consideration of food use, the increases of the amount and kind of chemicals are undesirable. From this viewpoint, the method of the present invention uses mechanical grinding for processing to a nano size.

The processing to a nano size in the present invention is more specifically described below.

In advance of processing to a nano size, the moisture value of pulp is measured, thereby calculating the solid content. On the basis of the value, water is added so as to adjust the pulp solid content amount to 0.01% to 5%.

Examples of the apparatus used for mechanical grinding for nanofiber processing include wet mills such as a bead mill, grinders, high pressure collision grinding apparatuses, ultrasonic homogenizers, and high pressure homogenizers.

When the food manufacturing by-product is almond seed coat, the pulp obtained from the almond seed coat can be processed into nanofibers with a very quick treatment.

When the apparatus to be used is, for example, an ultrasonic homogenizer, the object can be gelated and cracked to a nano level with irradiation for about continuous 3 to 15 minutes.

The nanofiber processing is possible by a combination of a plurality of apparatuses. For example, an ultrasonic homogenizer and a high pressure homogenizer may be combined.

Nanofiber processing is possible with any grinder, but the applicable apparatuses are limited by the solid content concentration, so that the apparatus is selected as appropriated according to the concentration to be treated and the treatment amount.

The object processed into nanofibers by mechanical grinding is, as necessary, charged into a desired container for the purpose of preventing bacterial contamination, followed by sterilization treatment and storage.

### EXAMPLES

The present invention is described in detail with reference to the following examples, but the present invention will not be limited to them.

### Example 1

<Alkali Cooking Treatment>

The moisture value of peeled almond seed coat was measured, the solid content of the seed coat was calculated, and a solid content of 10 g was obtained. Through the peeling operation, the moisture value of the seed coat became about 65%.

The pressure vessel used for alkali cooking was SUS316 manufactured by Taiatsu Techno Corporation with pressure resistance of 7 Mpa.

Sodium hydroxide was used as an alkali, the sodium hydroxide concentration was 15% with reference to the seed coat solid content, and the liquid ratio was 1:8 so as to make the whole seed coat immersed in the liquid.

For 10 g of the seed coat solid content, 1.5 g of NaOH was dissolved in 79 g of water, they were charged into the pressure vessel, the valve was closed so as not to leak the pressure, and immersed into an oil bath heated to 170° C.

After the internal temperature reached the vicinity of 170° C., the temperature was held for 90 minutes.

After completion of holding, the vessel was taken out from the oil bath, the pressure vessel was cooled with water, the content was taken out, and the alkali cooking liquid and the pulp was separated.

The alkali cooking treatment eliminates lignin from the almond seed coat. The solid content is further decreased by bleaching. Usually, the yield of pulp until completion of bleaching is about 15 to 30%.

<Washing Treatment>

The following bleaching treatment process is carried out at pH 10 or more, so that rinsing is finished after the black liquid is separated, and rinse water became about pH 9 to 10. In the present experiment, rinsing and washing were carried out according to this manner.

<Bleaching Treatment>

Sodium hypochlorite (NaClO) was used as a chemical which is acceptable for food use.

The moisture of the cooked pulp was measured, and the solid content was calculated. The solid content was 100 g.

In advance of NaClO bleaching, O₂ bleaching was carried out. At that time, the pulp was placed in a pressure vessel, treated with a NaOH aqueous solution for adjusting the pH to 11 or more, and O₂ was blown into the vessel. After purging two to three times, O₂ was sealed with a pressure of 7 kg/cm², the pulp was immersed into hot water at 100° C., and allowed to react for one hour.

After completion of O₂ bleaching, the pulp was treated with a NaOH aqueous solution so as to adjust the pH to 10 or more.

Subsequently, a 8% NaClO aqueous solution was added in an amount of 6% of the solid content, and the liquid ratio was adjusted to 1:3. These objects were placed in a sealing bag, sealed by heating, and immersed into warm water at 70° C.

The bag was kneaded with hand occasionally, NaClO was spread over the entire area, and the reaction was waited.

The reaction was confirmed at intervals of 30 minutes, and NaClO was added twice.

The bleaching herein is aimed at removing redundant lignin from the pulp, so that excessive whitening is unnecessary.

<Washing Treatment>

The subsequent process is processing to a nano size, so that washing herein must be carried out so as not to left chemicals.

Water used for washing is distilled water, purified water, or an equivalent, and washing was repeatedly carried out by suction filtration with a Buchner funnel. After confirming that the pH became the same pH as distilled water, the boiling state was held for 10 minutes in final washing, thereby removing hypochlorous acid. After boiling, water was removed by a Buchner funnel.

<Processing to Nano Size>

Mechanical fibrillating was chosen herein for processing of the pulp component to a nano size, and a circulating ultrasonic homogenizer (UH-6005, manufactured by SMT Co., Ltd.) was used therefor.

The moisture of the bleached and dehydrated pulp was measured, the solid content was calculated, thus obtaining a pulp liquid with a solid content concentration of 2%.

In advance of processing to a nano size, the pulp was cracked with a homomixer (MARK II, PRIMIX Corporation) for five minutes.

The output of the circulating ultrasonic homogenizer was adjusted to 600 W, and the oscillation frequency was adjusted to 20 KHz.

In this state, the whole liquid was circulated so as to be irradiated with the ultrasonic homogenizer for three minutes.

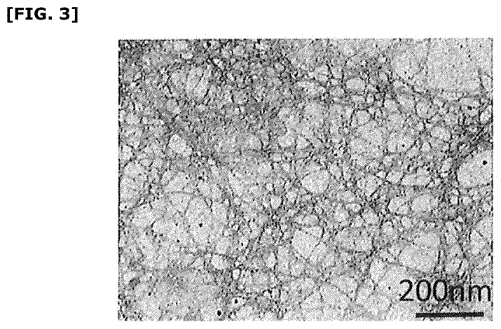

The object thus obtained was gelatinous CNF with a fiber diameter of several nm to 100 nm and a length of 500 nm to several μm as observed with a transmission electron microscope (TEM), and the aspect ratio representing the thickness and length of the fiber was 100 or more (diameter: several nm to 100 nm, length: 100 times or more the diameter) (FIG. 3). It was confirmed that the object was derived from cellulose by X-ray diffraction.

What is claimed is:

1. A method for producing cellulose nanofiber (CNF) comprising:
alkali cooking a food manufacturing by-product containing plant fiber using an alkali acceptable for food use, followed by washing with water;
bleaching a pulp component containing cellulose and hemicellulose thus obtained using a chemical acceptable for food use, followed by washing with water; and then
mechanically fibrillating and grinding the pulp component obtained above, thereby obtaining cellulose nanofiber.

2. The method according to claim 1, wherein the food manufacturing by-product containing plant fiber is selected from the group consisting of almond seed coat, bean curd refuse, rice bran, and wheat bran.

3. The method according to claim 1, wherein the food manufacturing by-product containing plant fiber is almond seed coat.

4. The method according to claim 1, wherein sodium hydroxide is used as an alkali acceptable for food use.

5. The method according to claim 1, wherein any one of sodium hydroxide, sodium hypochlorite, ozone, oxygen, hydrogen peroxide, or a mixture of these chemicals is used as a chemical acceptable for food use.

6. The method according to claim 1, wherein processing to a nano size by mechanical fibrillating and grinding is carried out using a wet mill, a grinder, a high pressure collision grinding apparatus, an ultrasonic homogenizer, or a high pressure homogenizer.

7. A cellulose nanofiber which is acceptable for food use obtained by the method according to claim 1.
